(19) United States
(12) Patent Application Publication
(10) Pub. No.: US 2002/0097142 A1
(43) Pub. Date: Jul. 25, 2002

(54) Biometric authentication device for use with token fingerprint data storage

(76) Inventors: Martin J. Janiak, Middleton, MA (US); Greg Wachter, Sun Prairie, WI (US); Alan Wood, Cottage Grove, WI (US); Kevin Booth, Verona, WI (US); David Taggart, Verona, WI (US)

Correspondence Address: WHYTE HIRSCHBOECK DUDEK S C, 111 EAST WISCONSIN AVENUE, SUITE 2100, MILWAUKEE, WI, 53202

(21) Appl. No.: 09/683,049

(22) Filed: Nov. 13, 2001

Related U.S. Application Data
(60) Provisional application No. 60/248,053, filed on Nov. 13, 2000.

(51) Int. Cl. H04Q 1/00; G05B 19/00

(52) U.S. Cl. 340/5.53; 340/5.6

(57) ABSTRACT

A biometric authentication device for use with a token such as button having biometric data stored thereon. The biometric device includes a fingerprint module having a fingerprint sensor for capturing a user's fingerprint placed onto the fingerprint sensor. The fingerprint module is capable of receiving and reading the token when placed on a token socket located on the biometric. device. The tokens contain user information, including electronic fingerprint information. The fingerprint module is capable of determining a match between the user's fingerprint captured from the fingerprint sensor and the electronic fingerprint information stored on the token. Determination of the match between the end user captured fingerprint and the stored electronic fingerprint information enables biometric verification or identification of the end user. Status indicators indicate to a user whether a successful match has occurred between the user supplied fingerprint and the biometric information stored on the token. The information may be transmitted to a central database and may be part of a network of biometric devices. The biometric device is useful in time and attendance, access and control as well as user identification and verification applications. Application program interface software used with the biometric device permits application specific solutions to be developed for biometric token applications.

### CROSS REFERENCE TO RELATED APPLICATIONS

This application claims the benefit of U.S. Provisional Application No. 60/248,053 filed Nov. 13, 2000.

### BACKGROUND OF INVENTION

The present invention relates generally to biometrics and biometric solutions, and more particularly to a biometric solution that combines a token having stored biometric data with a live capture biometric system that is useful in identification, time-and-attendance and access-and-control applications.

The field of biometrics, or the measuring of a physical characteristic used to recognize the identity or verify the claimed identity of an individual, has emerged as an increasingly reliable methodology for verification (one-to-one) and identification (one-to-many) of individuals. Biometrics has become a very powerful tool in the solving of problems associated with requiring positive identification of individuals.

Live capture biometrics, which is the process of capturing a biometric sample by an interaction between an end user and a biometric system, requires a significant amount of memory, processing power and communication capabilities to quickly and accurately perform the biometric functions assigned. A high level of functionality, and correspondingly, processing power, is required to: read from and write to memory and smart cards or tokens; read fingerprint sensors; extract minutia; and compare against stored fingerprint data. Oftentimes, the resultant product may be prohibitively bulky, expensive and complicated so as not to be readily adapted for commercial applications, particularly for those biometric applications that require verification or identification from a variety of locations. Additionally, such devices are not readily adaptable application-to-application, and the entire unit must be reconfigured in order to run the desired biometric application.

Additionally, the use and functionality of token-type data storage devices has seen a dramatic rise. Increasingly, the portability and widespread use of these devices in easily usable formats makes biometric identification of individuals faster, more reliable and more convenient.

Therefore, there exists a continuing need for a compact biometric system that is readily connectable to and is readily usable with available data storage devices having the requisite memory, processing power and convenience necessary to perform the biometric function for the particular application. Additionally, there exists the need for a biometric solution that can be easily integrated into an application specific software to allow for customized applications of the fingerprint verification and identification technology.

### SUMMARY OF INVENTION

The present invention provides a biometric authentication device and overcomes the aforementioned problems, and provides a biometric authentication device that may be used with a telecommunications device to yield a biometric solution.

In accordance with one aspect of the invention, a biometric device for use with a button token includes a fingerprint module having fingerprint sensor for reading a fingerprint and generating fingerprint data, and electronic circuitry located within the fingerprint module which is connected to the fingerprint sensor to process the fingerprint data. The biometric device is connectable to and usable with button token to compare the generated fingerprint data to the stored fingerprint data on the button token.

In accordance with another aspect of the invention, a biometric device for use with token and a token holder is disclosed and includes a fingerprint module including a fingerprint sensor for reading a fingerprint of the token holder. The fingerprint module is receptive to and connectable with the token to allow electronic communication with token. The fingerprint module includes a plurality of contacts adapted to receive and read the fingerprint information stored on the token, and the fingerprint module is capable of determining a match between the fingerprint read from the fingerprint sensor and the stored fingerprint information on the token.

In another aspect of the invention, a biometric identification module for use with a token comprises a housing, and a biometric sensor exposed through the housing for obtaining user biometric data. The biometric identification module also includes a receiving portion receptive to a biometric data storage device having stored biometric data, and electronic processing and storage circuitry disposed within the housing and connected to the biometric sensor. The module also includes an application program interface programmed into the processing and storage circuitry to compare the user biometric data to the stored biometric data.

In another aspect of the invention, a biometric solution system for use with a token is disclosed and includes a biometric identification module. The biometric identification module includes a housing, and a biometric sensor exposed through an outer surface of the housing. The system further includes a token, the housing further including a receiving portion receptive to the token. An application protocol interface programmed into the module. The application protocol interface is capable of being used in conjunction with an application specific software to provide a customized biometric application solution useable with the token. In another aspect of the invention, a method of identification is disclosed. The method includes providing a biometric device comprising a fingerprint module including a fingerprint sensor for reading a user fingerprint placed on the fingerprint sensor, the fingerprint module including a token-receiving portion to receive a token having electronically stored fingerprint data therein. The method further includes placing a token onto the token receiving portion, reading the stored fingerprint data from the token, placing a user fingerprint onto the fingerprint sensor, reading the user fingerprint, generating live user fingerprint data, comparing the stored fingerprint data to the live user fingerprint data, and indicating a result of the comparison step.

Various other features, objects and advantages of the present invention will be made apparent from the following detailed description and the drawings.

### BRIEF DESCRIPTION OF DRAWINGS

The drawings illustrate one mode presently contemplated for carrying out the invention.

In the drawings:

FIG. 1 is a perspective view illustrating a biometric system in accordance with the present invention using several different tokens;

FIG. 2 is top plan view showing the biometric system during use comparing live fingerprint data to stored fingerprint data;

FIG. 3 shows a side perspective view of one embodiment of the present invention taken along line 3-3 of FIG. 2;

FIG. 4 is side exploded view of FIG. 3;

FIG. 5 is a functional diagram illustrating a system of biometric devices in accordance with one aspect of the present invention; and

FIG. 6 is a functional block diagram illustrating the biometric solution system in accordance with one aspect of the present invention.

### DETAILED DESCRIPTION

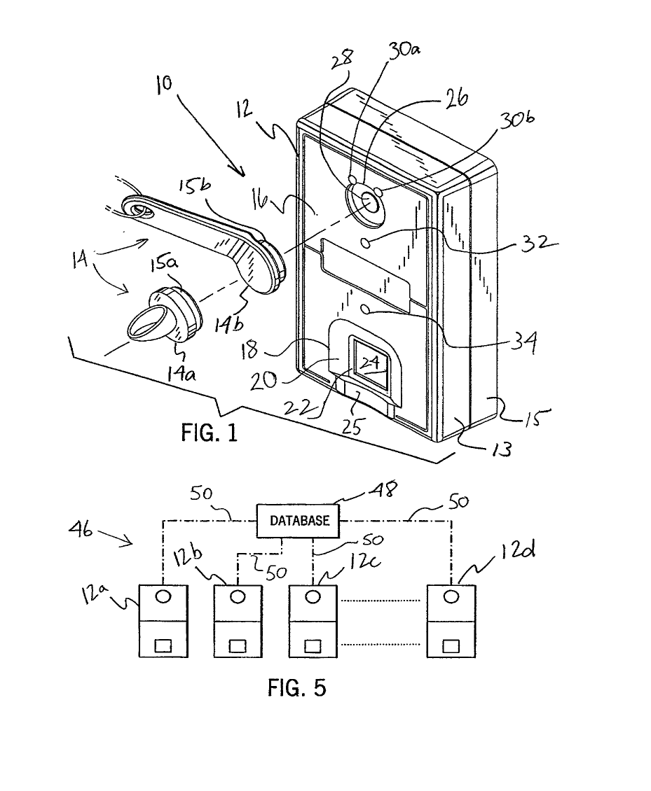

Referring now to FIG. 1, the biometric system of the present invention is shown generally by the numeral 10. The current system is sold under the name GuardDog_{TM}. It is an TM intelligent device that can verify the identity of an individual by scanning the actual fingerprint and comparing the scanned print with fingerprint data (also called a template) printed or stored on tokens 14. The biometric system 10 includes a fingerprint identification module (FIM) or biometric hub or unit 12 that reads and compares live biometric data (such as fingerprints) to stored biometric data which is found in tokens 14. FIM 12, which includes front and back sections 13 and 15, is shown prior to contact with any of tokens 14. Generally, in a preferred embodiment, FIM 12 is shown as a generally rectangular box, but may take any suitable form such that it may be easily connected with and usable with tokens 14. FIM 12 includes a top surface 16, which is at least partially defined by a ridge 18. Ridge 18 defines an inner wall 20, which extends to fingerprint read surface 22. Along read surface 22 is a fingerprint read field or fingerprint sensor 24. Wall 20 may take on shapes other than those specifically shown, such as a semiparabolic or other shape that facilitates user placement of a finger onto fingerprint sensor 24. However, the shape of ridge 18 and wall 20 is important in that it exposes an area on the fingerprint read surface 22 such that a user may place a finger onto fingerprint sensor 24 while guiding the user finger to sensor 24, and guide 25 assists in guiding the finger and properly aligning the finger to sensor 24.

Tokens 14 are devices having stored data, such as biometric data, that serve as a sign of authority or identity. Tokens come in many different varieties including 2-D barcoded cards (optical cards), memory cards (having embedded EEPROM (memory chips), smart cards (having an embedded memory chip and a microprocessor), and button-type tokens 14 as shown in FIG. 1. Button-type tokens are generally rugged steel buttons that have embedded computer chips armored in a stainless steel can 15a and b. Because of the durable package, button-type tokens are used in many applications, because the steel buttons are generally rugged enough to withstand harsh outdoor environments, and they are durable enough for a person to wear as an accessory. One suitable button-type token is the iButton® brand manufactured by Dallas Semiconductor Corp. of Dallas, Tex., a wholly owned subsidiary of Maxim Integrated Products. Button-type tokens may be fashioned into items such as rings 14a, key fobs 14b, wallets, watches, metal cards, or badges. Other biometric solutions may require other token devices, and it is contemplated by the present invention that any type of suitable token may be used and is considered to be within the scope of the present invention. Tokens 14 come in read only and read-write varieties, including 16-bit and 64-bit computer chips. In the present invention, the tokens 14 are used to store, among other data, biometric data. Some tokens may contain a real-time clock to track the number of hours a system is turned on for maintenance and warranty purposes. Tokens may also contain a temperature sensor for applications where spoilage is a concern, or a transaction counter that allows the token to be used as a small change purse. Information is transferred between the token and the fingerprint identification module with a momentary contact, at present this is at speeds of up to 142 bits per second. It is only necessary to contact the token to the receptor socket. Generally a system requires a token (such as an iButton), a host system, a reader-writer device to get information in and out of the token, and a layer of software to interface the token to the host system and then produce the desired information in the desired format. Usable software platforms include the iButton-TMEX on which to build applications. FIM 12 includes a token reception socket 26, which is the area into which tokensare inserted, and therefore token reception socket is shaped to correspond to the shape of the token to be received, for example circular in a preferred embodiment. Socket 26 has a center contact 28 with which primary electrical contact with the token 14 will be made in one embodiment. About the circumference of socket 26 are two secondary contacts 30a and b. In addition to contact with center contact 28, tokens 14 must also contact at least one of contacts 30a and b in order for biometric data to be read from tokens 14. Any number and arrangement of contacts are contemplated in order to provide additional directions and placement positions for the token 14 to be placed onto socket 26 and be successfully read.

FIM 12 also includes token status indicator 32 and fingerprint sensor status indicator 34. Both indicators 32, 34 are preferably LEDs that indicate (with the use of varying colors and blinking/steady states) the status and conditions of the token/token socket connection and the fingerprint/fingerprint sensor read operations, respectively. Although not shown, an audible indicator is also contained within FIM 12, typically a buzzer, although other audible indicators are possible. The audible indicator works in conjunction with indicators 32 and 34 to convey in both visual and audible form the status and conditions of biometric system 10.

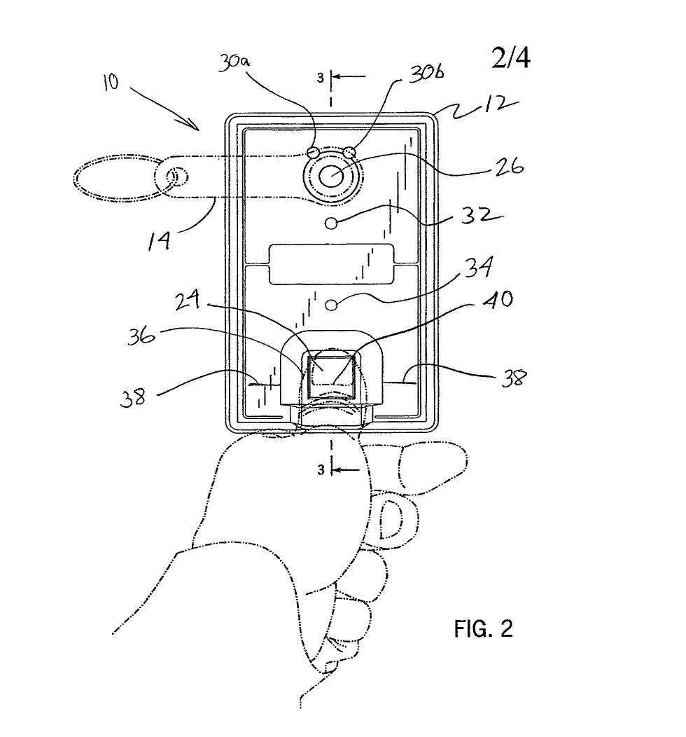

Referring now to FIG. 2, biometric system 10 is shown with FIM 12 in contact with token 14 and with a user finger (or thumb) 36 placed upon sensor 24. In operation, token 14 is placed in contact with center contact 26 and at least one of contacts 30a and b such that an electronic connection is established. Also, the user places a finger 36 from which live biometric information may be extracted by fingerprint sensor 24. In order to assist the user, the front surface 16 includes cuticle guide lines 38 that can be lined up with the cuticle 40 of the user such that optimal placement of user finger 36 is accomplished.

A key fob token 14 is shown. Token 14 is designed to withstand moisture, heat and cold, and may come in any form that is capable of storing fingerprint data for an enrollee (the token holder). An enrollee is a potential user of the system who has gone through the enrollment process, or the process of collecting biometric samples from a person and storing the biometric samples on token 14 for comparison to the end user's biometric sample. The verification is performed at the device, so it is not required that fingerprint data need be stored in or transmitted to a central database.

Exemplary Operation

When FIM 12 first receives power, it performs internal self-tests and initialization procedures. Upon successful completion, fingerprint status indicator (LED 34) in a preferred embodiment blinks red, amber, and green and the unit “chirps” twice. The unit is ready to be used when indicator 34 is blinking green. In a preferred embodiment, the color of the LED generally indicates the conditions listed as follows:

Color green

condition Ready or accepted

Color red

condition Rejected

Color amber

condition Reading or scanning in progress

In order to use the biometric system 10, the user inserts the token 14 into the token receptor or socket 26. Because of the particular contact points of the token, the token must touch, in this embodiment, the center contact 26 and at least one of the upper top contacts 30a and b. During this period, LED 32 turns amber while FIM 12 is reading the button or token 14. After an audible indicator or chirp, and when the fingerprint sensor LED 34 is blinking green, the button token 14 may be removed from the token receptor or socket 26. The user then places a finger 36 on the fingerprint sensor 24. While the finger 36 of the user is being scanned, fingerprint sensor LED 34 turns amber. After an audible indicator chirps and when the fingerprint sensor LED 34 turns off, the user removes the finger 36. At this point, if biometric unit 12 emits three very quick audible indicators and both the token status indicator LED 32 and the fingerprint sensor status LED 34 start to blink green, it is an indication that the verification has been successful. However, if the unit 12 emits only a single chirp and the fingerprint sensor status LED 34 starts to blink green again, the unit was unable to verify the user. It is then necessary to reposition the user finger and repeat the process. In some applications, it is necessary only to start with the user placing the finger 36 back onto the fingerprint sensor 24. If after three tries, a verification cannot be made, both LEDs 32 and 34 blink red and unit 12 emits three long beeps. Unit 12 advantageously has an etched line 38 on both sides of the fingerprint sensor to help the user properly position the user's finger 36. To aid this process, cuticle 40 should be aligned with the lines 38 at the left and right of the sensor.

LED and Sound Conditions

The following tables list normal operating and error conditions.

GuardDog Normal Operating Conditions

| Token | Fingerprint | | |
|---|---|---|---|
| LED | Sensor LED | Sound | Indicates |
| Blinking green | Off | None | Okay to insert token |
| Amber | Off | None | Reading token |
| Off | Blinking green | Single chirp | The token was read. |
| | | | Place or reposition |
| | | | finger on sensor. |
| Off | Amber | None | Reading fingerprint. |
| Blinking green | Blinking green | Triple chirp | ID verified and access |
| | | | granted |

GuardDog Error Conditions

| | Finger- | | | |
|---|---|---|---|---|
| | print | | | |
| Token | Sensor | | | |
| LED | LED | Sound | Indicates | What to Do |
| Blinking | Off | None | Cannot read Token. | Wait until the |
| red | | | | token LED is |
| | | | | blinking green |
| | | | | and reinsert the |
| | | | | token. |
| Blinking | Blinking | Three long | Access denied. The | Wait until the |
| red | red | beeps | fingerprint template | token LED is |
| | | | on the Token. | blinking green |
| | | | | and try to |
| | | | | authenticate |
| | | | | yourself again. |
| | | | | Refer to |
| | | | | “Finger |
| | | | | Selection |
| | | | | and Placement |
| | | | | Tips” for |
| | | | | advice. |
| Off | Off | None | Unit is not receiving | Contact your |
| | | | power. | system |
| | | | | administrator. |

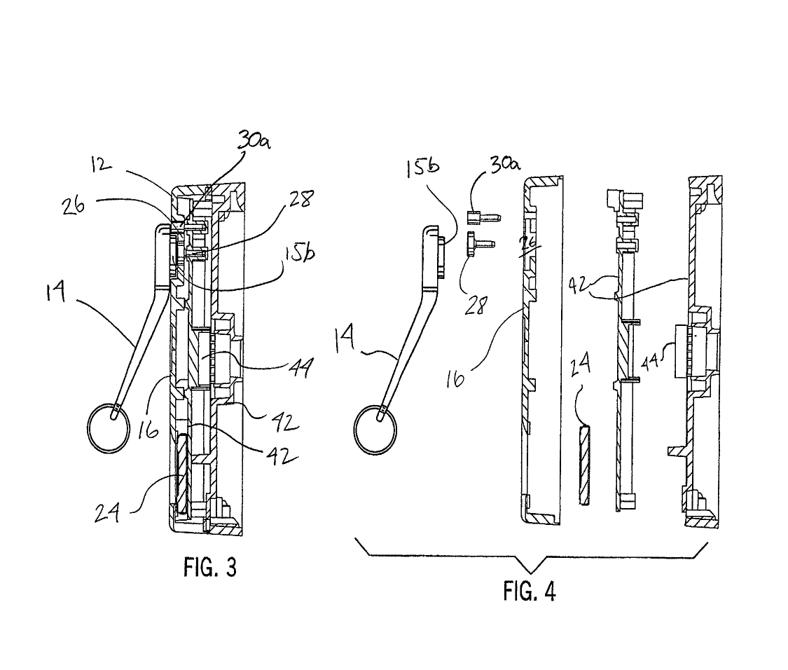

Referring now to FIGS. 3-4, a cross-section of biometric system 10 is shown with token 14 both engaged with the socket 26 of FIM 12 and exploded to facilitate understanding of the connections. Token 14 (in this case a keyring fob) has button portion 15b. Button portion 15b is fit into socket 26 until it touches center contact 28 and at least one of the outer contacts (such as 30a shown). These contacts are exposed through front surface 16 and, when engaged with token 14, establishes an electrical connection therebetween such that the data stored on token 14 may be read. This information is compared to the live fingerprint data read from sensor 24, also exposed through front surface 16.

Electrical connections between the fingerprint sensor 24, token 14, contacts 28 and 30a and the system electrical processor and memory are made through circuit boards 42. Circuit boards 42 include electronic circuitry, including chip 44, located within the fingerprint module 12 that are electrically connected to the fingerprint sensor 24 to process the fingerprint data generated by the fingerprint sensor 24 and compare it to the token 14 generated data as supplied through contacts 28 and 30a.

Within the circuitry is the software programming, particularly the application programming interface (API). API is a generalized instruction set that will expose the capabilities of the FIM 12 to a developer of custom applications. API s a portable interface that can be preferably ported to and compiled on any platform that offers a C compiler for development. This may include all Windows 9x, Windows CE, Geos and Palm operating system environments. Moreover, it is anticipated that any programming language that can make C type calls can be used to develop applications that utilize API. As contemplated by the present invention, the primary FIM functionality offered via the control will be notification of token 14 insertion into the FIM, reading of the token data, providing a channel to the fingerprint reader to receive a data stream, extracting fingerprint minutia from the data, and comparing the extracted minutia to that stored data, which is retrieved from the token 14. Under the umbrella of the API and the FIM device driver is application specific code. Application specific code is programming code, preferably window CE, that is specific to the application and/or problem being addressed by the biometric solution system. It includes any user interface code, and any business logic that is necessary to reside the token. The code also supports any data storage and transmission to a host PC, for example. Such code could be available off the shelf, such as a standard chip card enrollment program, a simple custom application that resides only in the portable biometric reader, or third-party integrators could use the API to construct customized or commercial applications.

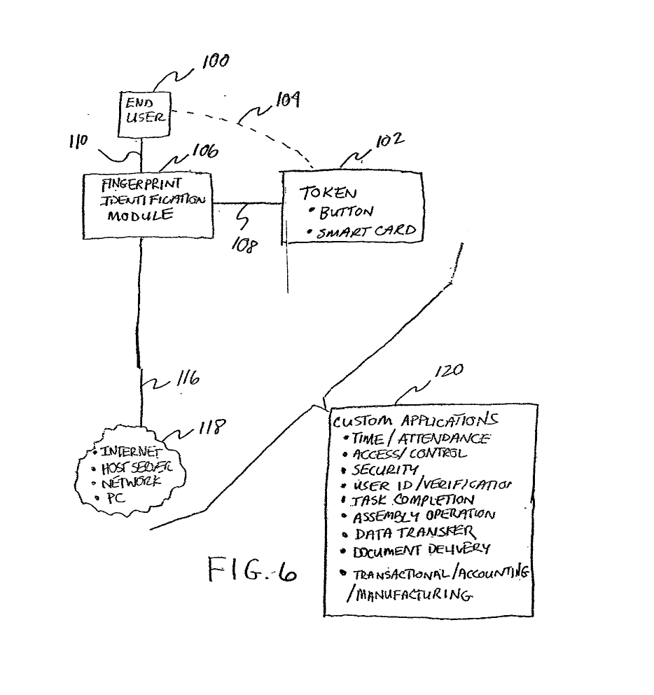

Referring now to FIG. 5, the present invention can be operated as a stand-alone unit or included in a network 46. Network 46 is made up of more than one biometric identification modules, and four are shown as 12a-d, although any number of modules or units in a network are possible as needed for a given application. The biometric system is designed to operate as individually connected devices or connected to a central database 48 through individual interfaces 50. Interfaces 50 may be configured as an RS-232 or RS-485 interface, for example. The RS-232 interface allows connection of a single unit to the serial port of a standard PC located close to the unit. The RS-485 interface allows connection of multiple units to a twisted pair LAN extending up to several hundred feet. Multiple units 12a-d can be connected into a single network, with multiple security groups. The units can also include an industry standard Wiegand output interface that supports the connection of electronic door locks.

Referring now to FIG. 6, a schematic representation of a biometric system in accordance with the present invention is shown as part of what is described as a biometrics anywhere initiative. In the system, an end user 100 goes through the process of enrollment, or the process of collecting and storing biometric samples from a person such that the stored biometric sample can be compared to a live biometric sample of the end user 100. The stored biometric sample is stored on a token 102, which may take many forms, including buttons or smart cards capable of reading, writing and computational capabilities, a memory card having read/write capabilities or an optical card where a single (or multiple) fingerprint image(s) is/are contained within a 2D barcode symbol, such as a PDF 417 patch, or printed on a plastic ID card. Token 102 may also include a memory card that includes a memory chip or button embedded within the card (chip card). The chip is capable of storing more information than the optical data card, but also permits the writing of transactional data to the chip while the token is inserted. The data can be downloaded later to another central location for the particular application. The data can then be erased from the memory card, thereby freeing up space for additional information storage. Additionally, the token may be a smart card, where transactional data can be collected and stored, but it also may be processed and used directly by the smart card, in particular applications. Therefore, a token which is read-only, read-and-write, or read-write-transactional is contemplated by token 102. In many cases, end user 100 may be in possession of the token 102. However, it is contemplated by the present invention that the token may reside at a particular location, with other tokens of similarly enrolled end users such as an end user 100. Given a particular application, it may be desired that the end user maintain possession of token 102. Regardless, token 102 represents stored biometric information of end user 100 and therefore there is a biometric link 104 between token 102 and end user 100. In the present invention, fingerprint identification module 106 receives information stored on token 102 through connection 108 (for example, by directly reading token 102). Alternatively, information contained on token 102 may be preprogrammed into fingerprint identification module 106, thereby eliminating the need to have a data card available during identification or verification of end user 100. Also, information contained on token 102 may be wirelessly transmitted via connection 108 to fingerprint identification module 106, for example, by the use of RF ID technology and proximity reading of token 102 where the actual token need not necessarily be physically inserted directly into the fingerprint identification module 106 in order to be read. End user 100 provides a live biometric sample 110 to be read by fingerprint identification module 106. Extraction then occurs, which is the process of converting the captured biometric sample into biometric data so that it can be compared to the data on token 102. Fingerprint identification module 106 works to determine a match or non-match of the live to stored biometric data, resulting in custom specific functionalities. Such information may be transferred via wireless or wired connection 116 to a network 118, which may include the Internet, a host server that may be part of a network or simply a resident PC. As noted, biometrics solutions possible with the above components may be fashioned into various custom applications 120, and such varying arrangements, as well as replication of the above model in a wide system may be utilized to effect such customized applications. For example, applications which require time and attendance records may be appropriate. Other custom applications 120 include access and control of facilities as well as security measures to prevent unauthorized entrance. There may be applications 120 that include simple user identification and verification to generate a record of those passing into a given situation, such as a classroom, etc. Additionally, other custom applications 120 may include the completion of a task, where a record may be sent when a given task has been satisfied, such as an assembly operation, a transfer of data, or delivery of an electronic document. The transfer of data may include other transactional, accounting, manufacturing or other data that is desired to be transmitted at particular times and by particular personnel. Contemplated applications may include: transportation—verification of receipt of goods, and checking of manifest for items delivered; education—identification of students and school personnel anywhere, matching of children and their caregivers when students are leaving school, verifying identity of test-takers in educational settings; aviation—verification of aircraft power plant or airframe repairs, identification of personnel for controlled access, secure luggage pickup and delivery; healthcare—providing proper administration of the correct pharmaceutical to the correct patient in a hospital or clinic setting, and registration of personnel who have access to controlled substances; and banking—tellers may have proof sheet on a telephone, to which is recorded the value of securities they started the day with, the total amount of new securities they took in or paid, and obtain an end of day balance, digitally signed with a fingerprint. Typical applications include stand-alone identity verification where the unit confirms that a person is the rightful holder of a token that he or she is carrying. Access control is also possible where the unit confirms the identity of the carrier of a token and interfaces with other control devices, such as alarms and door latches. In an access control application, the unit can work autonomously (storing all access control information locally) or in a network configuration with critical information (other than fingerprint information) stored on a security server. Time and attendance applications include where the unit confirms identity of a token carrier and also generates a log entry for each transaction. The custom applications may be utilized wherever there is a desire for a biometric digital signature, to create a biometrics anywhere solution.

A method of identification is disclosed in the present invention The method includes providing a biometric device comprising a fingerprint module including a fingerprint sensor for reading a user fingerprint placed on the fingerprint sensor, the fingerprint module including a token-receiving portion to receive a token having electronically stored fingerprint data therein. The method further includes placing a token, preferably a button, onto the token receiving portion, reading the stored fingerprint data from the token, placing a user fingerprint onto the fingerprint sensor, reading the user fingerprint, generating live user fingerprint data, comparing the stored fingerprint data to the live user fingerprint data, and indicating a result of the comparison step. The indicating step can include activating an LED to indicate one of a match and a non-match between the electronically stored fingerprint data in the button and the user fingerprint as read on the fingerprint read field.

The steps of the methods described and claimed herein are set forth to provide the teachings of best mode and preferred embodiments of the invention, for purposes of clarity and particularity, and are not provided by way of limitation. The steps can be combined, divided, interchanged or otherwise rearranged, with such and other changes, alterations and modifications apparent to one of skill in the art and contemplated and within the scope of the present invention.

The present invention has been described in terms of the preferred embodiment, and it is recognized that equivalents, alternatives, and modifications, aside from those expressly stated, are possible and within the scope of the appending claims.

1. A biometric device for use with a button token having stored fingerprint data comprising:
a fingerprint module having a fingerprint sensor for reading a fingerprint and generating fingerprint data; and
electronic circuitry located within the fingerprint module and connected to the fingerprint sensor to process the fingerprint data; and
wherein the biometric device is connectable to and usable with button token to compare the generated fingerprint data to the stored fingerprint data on the button token.

2. A biometric device for use with a token having stored fingerprint information and a token holder comprising:
a fingerprint module including a fingerprint sensor for reading a fingerprint of the token holder, the fingerprint module receptive to and connectable with the token to allow electronic communication with the token, wherein the fingerprint module includes a plurality of contacts adapted to receive and read the fingerprint information stored on the token, and wherein the fingerprint module is capable of determining a match between the fingerprint read from the fingerprint sensor and the stored fingerprint information on the token.

3. The biometric device of claim 2 wherein the token includes a button.

4. The biometric device of claim 3 wherein the button is part of one of a fob and a ring.

5. The biometric device of claim 2 wherein determination of the match between the token holder fingerprint and the fingerprint information stored on the token enables biometric identification or verification of the token holder.

6. The biometric device of claim 2 wherein the biometric device generates user information, the user information selected from the group consisting of user entry time, user exit time, user check-in time and user attendance.

7. The biometric device of claim 2 wherein the biometric device generates information to selectively grant the token holder access to a desired location or control of a desired device.

8. The biometric device of claim 2 wherein the biometric device further generates information to identify or verify an identity of the token holder.

9. A biometric system comprising: a button token having at least one application therefor; a fingerprint module connectable with the token such that the fingerprint module may be utilized in conjunction with the token to provide a biometric solution for the at least one application.

10. A fingerprint module for use in a biometric authentication system, the fingerprint module including a fingerprint sensor and wherein the fingerprint module is capable of connection to and operation with a storage button having stored biometric data, the fingerprint module receiving live biometric information from the fingerprint sensor and comparing it to the stored biometric data as part of the biometric authentication system.

11. A biometric device for use with a token comprising:
a biometric module adapted for communication with the token, and wherein the biometric module includes an application programming interface software that can be customized to interface with the token.

12. A biometric identification module for use with a biometric data storage device comprising:
a housing;
a biometric sensor exposed through the housing for obtaining user biometric data;
a receiving portion exposed through the housing and receptive to the biometric data storage device having stored biometric data;
electronic processing and storage circuitry disposed within the housing and connected to the biometric sensor; and
an application program interface compatible with the biometric data storage device programmed into the processing and storage circuitry to compare the user biometric data to the stored biometric data.

13. The biometric identification module of claim 12, wherein the application program interface is compatible with additional programming to obtain application specific output and functionalities for the biometric identification module.

14. The biometric identification module of claim 12, wherein the stored biometric data and the user biometric data are fingerprint data.

15. A biometric solution system comprising:
a biometric identification module comprising:
a housing; and
a biometric sensor exposed through an outer surface of the housing to receive live biometric samples;
a token having stored biometric data, the housing further including a receiving portion receptive to the token; and
an application protocol interface programmed into the module,
wherein the application protocol interface is capable of being used in conjunction with an application specific software to provide a customized biometric application solution useable with the token.

16. The biometric solution system of claim 15, wherein the token is a button. having fingerprint data stored thereon.

17. The biometric solution system of claim 15, further including an Internet server in electronic communication with the biometric identification module for communication to a central database.

18. The biometric solution system of claim 15, wherein the biometric identification module is electronically connected to one of a PC, a host server, and a network for collection and storage of data.

19. The biometric solution system of claim 15, wherein the live biometric samples are fingerprints.

20. A biometric network comprising:
a plurality of biometric devices, each biometric device comprising:
a fingerprint module including a fingerprint sensor for reading a user fingerprint placed onto the fingerprint sensor, wherein the fingerprint module includes a portion adapted to receive and read a button token having electronic fingerprint information, and wherein the fingerprint module is capable of determining a match between the user fingerprint read from the fingerprint sensor and the electronic fingerprint information; and
a server having a connection to each of the plurality of biometric devices to receive data from each of the plurality of biometric devices.

21. The biometric network of claim 20 wherein the server is connected to the Internet.

22. The biometric network of claim 20 wherein the connection is wireless.

23. A biometric device comprising a fingerprint module including a fingerprint read field for reading a user fingerprint placed on the fingerprint read field, the fingerprint module including a button-receiving portion to receive a button having electronically stored fingerprint data therein such that the user fingerprint may be compared to the electronically stored fingerprint data when the button is placed into the button-receiving portion of the fingerprint module, and wherein at least one indicator is activated to indicate one of a match and a non-match between the electronically stored fingerprint data in the button and the user fingerprint read on the fingerprint read field.

24. The biometric device of claim 23 wherein the indicator is an LED.

25. The biometric device of claim 23 wherein the indicator is a buzzer.

26. The biometric device of claim 23 wherein the button is circular.

27. The biometric device of claim 23 is secured by a button carrier and wherein the button carrier is capable of being carried on a key chain.

28. The biometric device of claim 23 wherein the indication of the match is communicated to a user of the biometric device.

29. The biometric device of claim 23 wherein the button further includes additional memory for storing additional information within the button.

30. A biometric device for use with a button token having stored fingerprint data comprising:
a fingerprint identification module having a fingerprint sensor to receive a user fingerprint and generate live fingerprint data;
a token socket to receive the button token thereon, the socket having a plurality of contacts to make an electrical connection to the button token and read the stored fingerprint data;
electrical storage and processing circuitry to compare the stored fingerprint data and the live fingerprint data;
a token indicator to indicate successful placement of the token into the token socket; and
a sensor indicator to indicate successful placement of the user fingerprint onto the fingerprint sensor.

31. The biometric device of claim 30 further including a central primary contact and a plurality of secondary contacts as part of the token socket, wherein the token contacts the primary contact and at least one of the plurality of secondary contacts to transfer stored biometric data on the token to the module.

32. The biometric device of claim 30 further including an audible indicator to indicate that the fingerprint sensor has completed scanning the user fingerprint.

33. The biometric device of claim 30 further including an audible indicator to indicate that the biometric unit token socket has completed reading the biometric data from the token.

34. A method of biometric identification comprising:
providing a biometric device comprising a fingerprint module including a fingerprint sensor for reading a user fingerprint placed on the fingerprint sensor, the fingerprint module including a token-receiving portion to receive a token having electronically stored fingerprint data therein;
placing the token onto the token receiving portion;
reading the stored fingerprint data from the token;
placing the user fingerprint onto the fingerprint sensor;
reading the user fingerprint;
generating live user fingerprint data;
comparing the stored fingerprint data to the live user fingerprint data; and
indicating a result of the comparing step.

35. The method of claim 34 wherein the indicating step includes activating an LED to indicate one of a match and a non-match between the electronically stored fingerprint data in the button and the user fingerprint read on the fingerprint sensor.

36. The method of claim 34 wherein the token is a button storage device.
